(19) United States
(12) Patent Application Publication
(10) Pub. No.: US 2004/0246869 A1
(43) Pub. Date: Dec. 9, 2004

(54) Disk-shaped optical data carrier with a cd and dvd information layer

(76) Inventor: Dieter Dierks, Pulhalm (DE)

Correspondence Address: John Lezdey, 4625 East Bay Drive, # 302, Clearwater, FL, 33764, US

(21) Appl. No.: 10/492,344

(22) PCT Filed: Oct. 11, 2002
(86) PCT No.: PCT/DE02/03828

(30) Foreign Application Priority Data
Oct. 11, 2001 (DE) 10150025.4

(51) Int. Cl. G11B 7/20

(52) U.S. Cl. 369/94; 369/280

(57) ABSTRACT

A disk-shaped optical data carrier having a first surface, a second surface, a CD information layer on which CD-standard data is stored, and a DVD information layer on which DVD-standard data is stored. A first reading light which captures the CD information layer enters the data carrier by the first surface. A second reading light which reads the DVD information layer enters the data carrier by the second surface. The DVD information layer is located approximately in the middle between the first and the second surface. A CD reading light which reads the CD information layer runs through the DVD information layer. The DVD reading light which reads the DVD information layer runs through the CD information layer.

### FIELD OF THE INVENTION

The invention refers to a disk-shaped optical data carrier,

with a first surface,

with a second surface,

with a CD information layer, on which data according to the CD standard are stored and which has a CD pit structure and a CD reflection layer and

with a DVD information layer, on which data according to the DVD standard are stored and which has a DVD pit structure and a DVD reflection layer.

Whereby a first reading light, which seizes the CD information layer, enters the data carrier through the first surface and a second reading light, which seizes the DVD information layer, enters the data carrier through the second surface.

### BACKGROUND OF THE INVENTION

Such data media are also called hybrid CD DVD. The data carrier of the kind initially specified is known from the PCT/US98/03844 or DE 299 14 540 U1. It is composed out of a half DVD substrate according to the DVD standard and of a CD substrate. Typically the half DVD has a thickness of 0.6 mm, the thickness the CD is within 1.2 mm. Taken together this amounts to 1.8 mm. This is outside of the standard prescribing that CDs and DVDs may not be thicker than 1.5 mm. This total thickness can be reached by making the CD somewhat thinner, as can be recognized from FIG. 4 of the PCT document, too. If necessary, also the DVD can be made slightly more thinner than 0.6 mm.

If the CD is thinner than 1.2 mm, optical conditions are no longer perfect. The reading light is not focused any longer accurately on the CD reflection layer. One can compensate the disadvantage caused thereby by increasing the size of the optical structure, which comprises pits and land, as such as within the standard permissible. This means, however, that the CD can only be filled with an overall memory content in the lower range of the standard, for example only about 500 MB. A full size CD with the data content, which is possible with a single CD, is not attainable with the hybrid DVD CD according to the state of the art. This is a drawback.

It is further unfavorable that a total thickness, which lies positively under 1.5 mm and thus within the standard, is only attainable with difficulties. Actually manufactured hybrid DVD CDs have a thickness, which is slightly above 1.5 mm. This is unfavorable too.

### SUMMARY OF THE INVENTION

It is the object of the invention to indicate a hybrid DVD CD, which on the one hand has a total thickness clearly thinner as 1.5 mm, for example less than 1.3 mm, and on the other hand offers the possibility to store the maximally admitted amount of data on the CD layer.

Starting from the disk-shaped optical data carrier of the kind initially specified this task is solved by the fact that the DVD surface is located approximately in the middle between the first and second surface, and that the CD layer is in direct proximity of the second surface, that CD reading light, which reads the CD layer, travels through the DVD information layer, that DVD reading light, which reads the DVD information layer, travels through the CD information layer, that the CD layer is partly transparent for DVD reading light, and that the DVD information layer is at least partly transparent for CD reading light.

Contrary to the hybrid data carrier known before, in the inventive data carrier the CD part and the DVD part are interlaced with one another viz. are stacked into one another. Whereas the data carrier according to the state of the art can in principle be separated by the bonding area between CD part and DVD part, whereby two thinner substrates are obtained, which both are fully functional per se, i.e. one substrate which is a (half) DVD and another substrate which is a CD, this is not possible with the hybrid CD DVD according to the invention. In this device the reading light capturing the DVD information layer traverses the CD information layer on its way to and on its way back. Same applies for reading the CD information layer. This reading light travels through the DVD information layer on the way towards and on the way back.

However, the basic principle of the disk-shaped optical data carrier according to the state of the art is maintained: In order to change from reading the DVD information layer to reading the CD information layer, the data carrier must be flipped over or turned.

From the state of the art hybrid DVD CDs are well-known, in which the CD information layer and the DVD information layer are read from the same surface of the data carrier, for this only exemplarily it is referred to EP 0737966 A, EP 0,520619 A, U.S. Pat. No. 4,450,553, EP 0,866,269 A, PCT/FR97/01090 and EP 0720159 A. In these before-known data carriers the DVD information layer is about 0.6 mm under the physical surface, the CD information layer is about 1.2 mm under the same physical entrance surface. This leads to problems when playing in a DVD player. As is well known, DVD players are capable to read also CD information, as they are downward compatible. These devices must be able to recognize whether they are to read the DVD information layer or the CD information layer. In principle they can read both layers. Which layer they will be supposed to read is communicated to them by a lead in information track, also called introduction track. It is, however, not possible to arrange for one or for two information tracks on the information surface, which make clearly an allocation possible both for CD and for DVD players. In addition a DVD player would have to offer an option to the user whether he would like to have read the DVD information layer or the CD information layer.

With the hybrid DVD CDs of the kind initially specified this problem does not exist. Here through both physical surfaces an information track is available for in each case. IF the CD information of the hybrid DVD CD is to be read with a DVD player, this player initially recognizes the information track, which is specified for conventional CD players, and recognizes the content thereof Thus an unambiguous allocation is given. In the data carrier according to invention this has the advantage that the DVD player does not have to adjust itself to the backface of the DVD information layer, although this layer is appropriately about 0.6 mm below the first disk surface and thus at a distance, which is within the standard and in which a DVD player DVD expects DVD-information.

The invention has the advantage that a total thickness of the data carrier of 1.2 mm is particularly optimal. Thereby it is not to be stated, that total thicknesses in the range around 1.2 mm are not also favorable. With a total thickness of approximately 1.2 mm the distance is as large as possible between the CD information layer and the DVD information layer. Thus the reading light is as little as possible focused at the place of one information layer during reading of the other layer. The disturbances caused by the second information layer are thus as small as possible in the context of the structure. A total thickness of 1.2 mm is, however, the standard for CDs and DVDs. Though the total thickness may, as was already mentioned, be up to 1.5 mm within the standard, there are multiple disk change-over players designed for data carriers having a thickness of only 1.2 mm. Besides this, material is saved, in this case in particular polycarbonate.

Further advantages and characteristics of the invention result from the remaining claims, as well as from the following description of embodiments of the invention, which will be described in the following with reference to the drawing. The drawing shows in:

### BRIEF DESCRIPTION OF THE DRAWINGS

FIG. 1: a sectional view of the data carrier and along a rather short portion of an information track,

FIG. 2: a sectional view as in FIG. 1, however, for a primary substrate, which contains an information track on both of its two physical surfaces.

FIG. 3: a representation like the one of FIG. 2, however, now with reflection layers on the surfaces.

### DESCRIPTION OF THE PREFERRED EMBODIMENTS

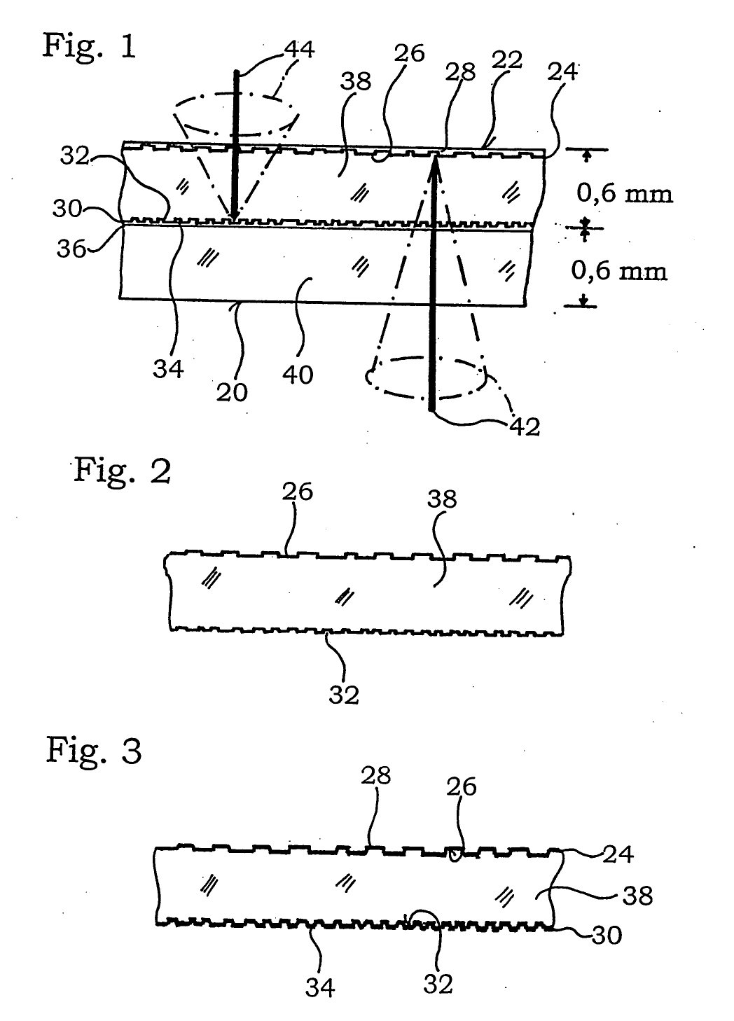

The disk-shaped data carrier has typically a diameter of 12 cm, but it can for example have a diameter of 8 cm. It is manufactured according to the standard for DVDs and/or CDs, it has a central hole (not represented) and introduction tracks. It has a first surface 20, which in FIG. 1 faces downwards. It further has a second surface 22. Both surfaces have a mutual distance of 1.2 mm. This distance can vary between 0.9 and 1.5 mm, preferably it is in the range between 1.1 and 1.3 mm. The surfaces 20, 22 are completely smooth in well-known way.

The data carrier is made of a plastic, for example polycarbonate, and consists of several individual disks and/or substrates, to which will be referred later. It has a CD information layer 24, which is in direct proximity of the second surface 22. This CD information layer exhibits a CD pit structure 26 and a CD reflection layer 28. In well-known way the pits are grooved into land, the pits have a greater distance from the first surface 20 than land.

Further the data carrier has a DVD information layer 30, which is in the middle between the first surface 20 and the second surface 22. This layer has a DVD pit structure 32 and a DVD reflection layer 34. Both are embodied after the DVD standard. The DVD pit structure 32 is more finely, thus smaller than the CD pit structure 26; this is positively shown in the figures by different sizes of the rectangular lines used for the pit structures. The DVD pits are located, seen from the second surface 22, below the associated land. Therefore the pits of the two pit structures 26, 32 face each other and the areas of land of these pit structures 26, 32 point away from each other.

FIG. 1 is drawn as far as possible true to scale. However, the distance drawn between pit and land is shown largely exaggerated, in order to be able to represent at all this distance. In reality the distance is smaller than the thickness of the line.

In direct proximity of the DVD information layer 30 is a bonding area, connecting range of connecting area 36, which is implemented as transparent as possible and as thin as possible. It practically does not contribute to the total thickness. Within the connecting area a “bonding” is performed, as it is well known for DVDs in principle.

The data carrier of FIG. 1 consists essentially of primary disk 38 and/or substrate, which carries on one of its physical disk surfaces the DVD information layer 30, and carries on the other physical disk surface the CD information layer 24, as well as f a secondary disk 40 and/or substrate. Both are about 0.6 mm thick, so that the total thickness amounts to 1.2 mm. The secondary substrate 40 is a disk without special characteristics; it does not carry information layers. It is made like the second dummy disk of a DVD-5. It forms the first surface 20.

FIG. 1 shows, too, how the two information layers 24, 30, also called information areas, are read. For this commercially available playing devices are used. It is to be particularly stressed here that it is not necessary to use special players, but on the contrary the data carrier can be used with every normal CD player and also with every normal DVD player.

Usually in playing equipment the data carrier is read and scanned from below, this is shown in FIG. 1 for the case of reading the CD information layer 24. CD reading light 42 enters the data carrier along with a main beam, which is drawn as a thick line, through the first surface 20. It penetrates the DVD information layer 30 and arrives at the CD information layer 24; there the reading light is focused in an as small dot and/or point as possible. After reflection at the CD reflection layer 28 the CD reading light travels 42 back the same path again. Around the main beam the actual, conical light volume or propagation is drawn in dash-dotted lines. One recognizes that the CD reading light is now also relatively broad 42 in the range of the DVD information layer 30. Reflections at this layer take place, but are small in their intensity and do not run back, i.e. do not enter with noticeable effect into the light receiving element of the playing equipment.

If it is intended to read the DVD information layer 30, the data carrier is inserted into a DVD player. For this it is flipped or turned in such a way that reading takes place now again from below. Only to the simplification of the representation the DVD reading light 44 is shown to enter from above in FIG. 1. In reality it comes as usual from below.

The DVD reading light enters the data carrier through the second surface 22. It penetrates the CD information layer which is in direct proximity of the second physical surface and is focused in the place of the DVD information layer 30 to an as small spot or point as possible, as thi is shown FIG. 1 also. After reflection at the DVD reflection layer 34 the light runs back again the same path. With a thick line the main beam and with dash-dotted lines the light cone, within which the light propagation takes place, is shown for the DVD reading light 44. It can be recognized that at the place of the CD information layer 24 the reading light is relatively unfocussed. Local reflections have thus a small intensity. In addition they do not travel back in the path of rays of the DVD reading light 44.

Altogether the penetration of the information layer of the other kind does weaken the intensity of the respective reading light; however, the information of the other kind does not disturb in each case otherwise the reading.

On the basis the FIGS. 2 and 3 a possible way of production of the data carrier will be described: First a primary substrate or disk 38 is manufactured. It strongly resembles a regular half DVD substrate and like this is also produced by injection molding of plastic, in particular polycarbonate. It has, however, additionally on its second surface a CD pit structure 26. On its other surface it has the DVD pit structure 32.

In a further production step the pit structures 26, 32 are now covered in each case with a corresponding reflection layer 28, 34. For this in particular semitransparent reflection layers are possible and suited, as they are used also in a DVD-9 for the Layer 0, thus for example 18 nm thick layers of gold or silicon. Also layers of about 10 nm thick of aluminum are possible. Higher layer thicknesses and/or other materials are possible, too. The reflection layer is, however, only just as thick as needed so that sufficient reflection ability for the reading light is reached and that the reading light of the other kind is weakened as little as possible.

The reflection layers mentioned so far have essentially an absorptive ability and a reflection ability, which both are independent from the wavelength in the range of the wavelengths of the reading lights to be regarded here (essentially 535-780 nm). It is now, in addition, possible to implement wavelength dependent reflection layers. A filter or a dye film is used, for this it is referred to the divulgation of the a.m. EP 0 886 269 A. Further reflection layers are taught in the PCT/FR97/01090, these are semi-permeable. They are for example manufactured from polydiacetylene or such a thing. It is expressly referred to the detailed divulgation in this document. The transmission and reflection can be adjusted in dependence in the wavelength by adjusting the thickness of the layer, for this e.g. it is referred to the FIGS. 3 and 6 of this document.

The CD reflection layer 28 has preferably as high a reflection ability for CD reading light 42 as possible, thus light with a wavelength within the range of about plus/minus 20 nm around 780 nm and as high a permeability for DVD reading light 44 as possible, thus light within the range of about plus/minus 20 nm around 635-650 nm. Appropriate considerations apply to the DVD reflection layer.

FIG. 3 shows the primary substrate 38 of FIG. 2, which now is covered, too, with a CD reflection layer 28 and DVD reflection layer 34. These reflection layers are extremely thin; they do not contribute practically to the total thickness.

In well-known way the primary substrate 38 is now glued or otherwise bonded with a secondary substrate 40, for this a UV-hardenable adhesive is used which is as thin as possible, as this is state of the art for the production of DVDs. The CD information layer 24 is covered with a protective varnish. This is well-known in the CD production and is a usual procedure. Now the production of the data carrier is finished.

In a alternative embodiment the primary substrate 38 only carries the CD information layer. The DVD information layer is embodied on the disk surface of the secondary substrate 40, which rests against the connecting range 36. It is inversely implemented compared with a usual DVD information layer of this substrate 40, since it is not read through the surface 20.

What is claimed

1. In a disk-shaped optical data carrier,
having a first surface and
a second surface,
a CD information layer, on which CD-standard data is stored, and which has a CD pit structure and a CD reflection layer,
with a DVD information layer, on which DVD-standard date is stored, and which has a DVD pit structure and a DVD reflection layer,
whereby a first reading light which captures the CD information layer enters the data carrier through the first surface, and a second reading light, which which reads the DVD information layer, enters the data carrier through the second surface,
the improvement which comprises that the DVD information layer is about the middle between first and second surface, said CD information layer is located in direct proximity of the second surface, that said CD reading light which reads the CD information layer travels through the DVD information layer, that said DVD reading light which reads the DVD information layer travels through the CD information layer, that said CD information layer is at least partially transparent with respect to DVD reading light and the DVD information layer is at least partially transparent with regard to CD reading light.

2. The data carrier according to claim 1, wherein the distance of the first surface from the second surface lies between 1.0 and 1.5 mm.

3. The data carrier according to claim 1, wherein the CD reflection layer has as high a reflection ability for light with a wavelength within the range around 780 nm and that it has as a large transparency for light with a wavelength within the range about 635-650 nm.

4. The data carrier according to claim 1, wherein the data carrier is comprised of several disk-shaped substrates which are glued to one another, and that the connecting ranges between neighboring substrates are optically permeable.

5. The data carrier according to claim 4, wherein the connecting ranges are thin.

6. The data carrier according to claim 1, wherein the DVD information layer is a first information layer of a DVD according to the DVD-9 standard and which is closer to the entrance surface, as the second deeper located information layer.
